(19) United States
(12) Patent Application Publication
(10) Pub. No.: US 2017/0204598 A1
(43) Pub. Date: Jul. 20, 2017

(54) CURVED SCREEN SUPPORT AND THEATER COMPRISING SAME

(71) Applicant: CJ CGV CO., LTD., Seoul (KR)

(72) Inventors: Bon Il KOO, Seoul (KR); Byoung Jun SONG, Incheon (KR); Hae Jeong KOH, Seoul (KR); Min Jung KIM, Seoul (KR); Young Mi KIM, Seoul (KR); Ok Sun KIM, Seoul (KR); No Chan PARK, Incheon (KR); In Jae SEONG, Seoul (KR); Young Wook CHOI, Seoul (KR)

(73) Assignee: CJ CGV CO., LTD., Seoul (KR)

(21) Appl. No.: 15/326,446

(22) PCT Filed: Jul. 15, 2015
(86) PCT No.: PCT/KR2015/007376

§ 371 Date: Jan. 13, 2017

(30) Foreign Application Priority Data
Jul. 15, 2014 (KR) 10-2014-0089365
Jul. 15, 2015 (KR) 10-2015-0100575

(51) Int. Cl. E04B 1/19; E04H 3/22; G03B 21/606

(52) U.S. Cl. CPC E04B 1/19; G03B 21/606; E04H 3/22

(57) ABSTRACT

The present invention relates to a curved screen support comprising a plurality of vertical bars arranged vertically from the ground, and a plurality of horizontal bars attached to the vertical bars at one end in the horizontal direction with respect to the ground, wherein horizontal bars are characterized in that the line connecting the other ends of the horizontal bars arranged on the same vertical axis has a curved shape of a set curvature, and the line connecting the other ends of the horizontal bars arranged on the same horizontal axis has a curved shape of set curvature. Therefore, according to the present invention, a curved screen having a curvature along the horizontal axis as well as the vertical axis can be stably held, and by controlling the curvature and angle of the curved screen, enhanced life-like effects can be provided to an audience.

### TECHNICAL FIELD

The present invention relates to a screen support having curvature and, more particularly, to a screen support having curvature including a plurality of vertical posts disposed in a vertical direction to the ground and a plurality of horizontal posts having one ends joined to the vertical posts in a horizontal direction to the ground, wherein a line connecting the other ends of the respective horizontal posts disposed in the same vertical axis forms a curve shape having curvature of a specific size and a line connecting the other ends of the respective horizontal posts disposed in the same horizontal axis forms a curve shape having curvature of a specific size.

### BACKGROUND ART

In general, a movie theater has a structure in which a rectangle screen is provided in a building of a rectangular parallelepiped having the vertical surface of a wall, and is fabricated to allow audiences to watch visual media within a specific space.

However, such a rectangle screen has structural problems in that a stereoscopic effect is not present and a sense of immersion is not sufficient because visual media is projected on a plane screen when audiences watch the visual media. Accordingly, various methods are recently suggested in order to solve such problems.

The present invention has been invented based on such a technological background and also has been invented to satisfy the aforementioned technological needs and to provide additional technological elements that may not be easily invented by those skilled in the art to which the present invention pertains.

### DISCLOSURE

### Technical Problem

The present invention has been made to solve the above problem, and an object of the present invention is to stably hold a screen and frame having curvature in a vertical axis in addition to a horizontal axis.

Furthermore, an object of the present invention is to enable an audience to feel various effects so that a high feeling of movement is transferred to the audience by controlling curvature of a screen having curvature and a screen frame having curvature according to the running time of a movie.

Furthermore, an object of the present invention is to enable an audience to feel various effects so that a high feeling of movement is transferred to the audience by controlling the height and angle of a screen along with the angle of an audience seat according to the running time of a movie.

Furthermore, an object of the present invention is to transfer a sound having a high sense for the real to an audience by providing a space where a speaker can be closely installed on a screen and to prevent an accident that a speaker falls due to a movement of a screen having curvature by fixing the speaker to a support.

Furthermore, an object of the present invention is to enhance a sense of immersion by providing a tilt to a screen so that the upper part of the screen becomes close to a field of vision of an audience.

Furthermore, an object of the present invention is to implement a stereoscopic effect within a screen because the screen has right and left and top and bottom curvature and thus to enable an audience to have a 3-D effect when watching a 2-D movie and to have a stereoscopic effect as if the audience watches a picture of an actual event when watching a 3-D movie.

### Technical Solution

To achieve the above objects, a screen support having curvature according to the present invention includes a plurality of vertical posts disposed in a vertical direction to the ground and a plurality of horizontal posts having one ends joined to the vertical posts in a horizontal direction to the ground, wherein a line connecting the other ends of the respective horizontal posts disposed in the same vertical axis may form a curve shape having curvature of a specific size, and a line connecting the other ends of the respective horizontal posts disposed in the same horizontal axis may form a curve shape having curvature of a specific size.

Furthermore, a horizontal post joined to the uppermost end of the vertical post may be inclined toward the ceiling at a specific angle or a horizontal post joined to the lowermost end of the vertical post may be inclined toward the ground at a specific angle. In this case, the horizontal post may have curvature of a specific size and may be joined to the plurality of vertical posts or a plurality of other horizontal posts disposed in the same horizontal axis. Furthermore, the vertical posts may be disposed in a 2-row or more line, and the horizontal post may be joined to a plurality of vertical posts in the same row or column.

Furthermore, in the horizontal post, an angle formed by a line connecting the other ends of a horizontal post at the uppermost and a horizontal post at the lowermost end disposed in the same vertical post and the vertical post may have 10 to 20 degrees. The screen support may further include a diagonal line post joined to one point of a vertical post to form an angle of 10 to 20 degrees along with the vertical post and a beam vertically joined to an adjacent diagonal line post. Furthermore, the screen support may further include a diagonal line post joined to one points of a plurality of horizontal posts disposed in the same vertical post to form an angle of 10 to 20 degrees along with the vertical post and a beam vertically joined to an adjacent diagonal line post.

Meanwhile, the length of the vertical post may be increased or decreased or a predetermined portion of the vertical post may be refracted at a predetermined angle. The length of the horizontal post may be increased or decreased or a predetermined portion of the horizontal post may be refracted at a predetermined angle.

A theater including a screen support having curvature according to the present invention includes a plurality of vertical posts disposed at specific intervals in accordance with a form of the surface of a wall in a theater and forming a vertical direction to the ground and a plurality of horizontal posts having one ends joined to the vertical posts in a horizontal direction to the ground, wherein a line connecting the other ends of the respective horizontal posts disposed in the same vertical axis may form a curve shape having curvature of a specific size, and a line connecting the other ends of the respective horizontal posts disposed in the same horizontal axis may form a curve shape having curvature of a specific size.

Furthermore, a horizontal post joined to the uppermost end of the vertical post may be inclined toward the ceiling at a specific angle, and a horizontal post joined to the lowermost end of the vertical post may be inclined toward the ground at a specific angle.

Furthermore, the horizontal post may have curvature of a specific size and may be joined to the plurality of vertical posts or a plurality of other horizontal posts disposed in the same horizontal axis. The vertical posts may be disposed in a 2-row or more line, and the horizontal post may be joined to a plurality of vertical posts in the same row or column.

Furthermore, in the horizontal post, an angle formed by a line connecting the other ends of a horizontal post at the uppermost and a horizontal post at the lowermost end disposed in the same vertical post and the vertical post may have 10 to 20 degrees.

Furthermore, the present invention may further include a diagonal line post joined to one point of a vertical post to form an angle of 10 to 20 degrees along with the vertical post and a beam vertically joined to an adjacent diagonal line post or may further include a diagonal line post joined to one points of a plurality of horizontal posts disposed in the same vertical post to form an angle of 10 to 20 degrees along with the vertical post and a beam vertically joined to an adjacent diagonal line post.

In this case, the length of the vertical post may be increased or decreased or a predetermined portion of the vertical post may be refracted at a predetermined angle. The length of the horizontal post may be increased or decreased or a predetermined portion of the horizontal post may be refracted at a predetermined angle.

Another screen support having curvature according to the present invention includes a plurality of vertical posts disposed in a vertical direction to the ground and a plurality of horizontal posts having one ends joined to the vertical posts, wherein a horizontal post joined to the uppermost end of the vertical post may be inclined toward the ceiling at a specific angle, a horizontal post joined to the lowermost end of the vertical post may be inclined toward the ground at a specific angle, and the horizontal posts may be joined to a screen frame having curvature.

In this case, in the horizontal post, an angle formed by a line connecting the other ends of a horizontal post at the uppermost and a horizontal post at the lowermost end disposed in the same vertical post and the vertical post may have an angle of 0 degree or more. More specifically, the angle may be 10 to 20 degrees.

Another theater including a screen support having curvature according to the present invention includes a plurality of vertical posts disposed in a vertical direction to the ground and a plurality of horizontal posts having one ends joined to the vertical posts, wherein a horizontal post joined to the uppermost end of the vertical post may be inclined toward the ceiling at a specific angle, a horizontal post joined to the lowermost end of the vertical post may be inclined toward the ground at a specific angle, and the horizontal posts may be joined to a screen frame having curvature.

In this case, in the horizontal post, an angle formed by a line connecting the other ends of a horizontal post at the uppermost and a horizontal post at the lowermost end disposed in the same vertical post and the vertical post may have an angle of 0 degree or more. More specifically, the angle may be 10 to 20 degrees.

A method for installing a screen support having curvature according to the present invention include the steps of (a) disposing a plurality of vertical posts in a vertical direction to the ground and (b) joining one ends of horizontal posts to the vertical post in a horizontal direction to the ground, wherein the step (b) may include disposing the horizontal posts so that a line connecting the other ends of the respective horizontal posts disposed in the same vertical axis may form a curve shape having curvature of a specific size and a line connecting the other ends of the respective horizontal posts disposed in the same horizontal axis may form a curve shape having curvature of a specific size.

Furthermore, at the step (b), a horizontal post joined to the uppermost end of the vertical post may be inclined toward the ceiling at a specific angle, and a horizontal post joined to the lowermost end of the vertical post may be inclined toward the ground at a specific angle. The method may further include the step of joining a horizontal post having curvature of a specific size to the plurality of vertical posts or a plurality of horizontal posts disposed in the same horizontal axis, after the step (b).

Furthermore, at the step (a), the vertical posts may be disposed in a 2-row or more line. The method may further include the step of joining a horizontal post to a plurality of vertical posts in the same row or column after the step (b).

Furthermore, at the step (b), an angle formed by a line connecting the other ends of a horizontal post at the uppermost and a horizontal post at the lowermost end disposed in the same vertical post and the vertical post may have 10 to 20 degrees. The method may further include the steps of joining one end of a vertical post and one end of a diagonal line post to form an angle of 10 to 20 degrees along with the vertical post and vertically joining a beam to an adjacent diagonal line post, after the step (b). The method may further include the steps of joining one points of a plurality of horizontal posts disposed in the same vertical post and a diagonal line post to form an angle of 10 to 20 degrees along with the vertical post and vertically joining a beam to an adjacent diagonal line post, after the step (b).

Another method for installing a screen support having curvature according to the present invention includes the steps of (a) disposing a plurality of vertical posts in a vertical direction to the ground and (b) joining one end of a horizontal post to the vertical post, wherein at the step (b), a horizontal post joined to the uppermost end of the vertical post may be inclined toward the ceiling at a specific angle, a horizontal post joined to the lowermost end of the vertical post may be inclined toward the ground at a specific angle, and the horizontal posts may be joined to a screen frame having curvature.

In this case, at the step (b), an angle formed by a line connecting the other ends of a horizontal post at the uppermost and a horizontal post at the lowermost end disposed in the same vertical post and the vertical post may have 0 degree or more. More specifically, the angle may be 10 to 20 degrees.

### Advantageous Effects

In accordance with the present invention, a screen having curvature can be stably installed without a change in the design of a building of a rectangular parallelepiped or a structure for viewing because a screen and frame having curvature in a vertical axis in addition to a horizontal axis is held.

Furthermore, the present invention can allow an audience to feel various effects by controlling curvature of a screen according to the running time of a movie.

Furthermore, the present invention can transfer the feeling of movement to an audience by controlling the height and angle of a screen having curvature along with the angle of an audience seat according to the running time of a movie.

Furthermore, the present invention can transfer a sound having a high sense for the real to an audience by providing a space where a speaker can be closely installed on a screen and can prevent an accident that a speaker falls due to a movement of a screen having curvature by fixing the speaker to a support.

Furthermore, according to the present invention, a sense of immersion can be enhanced by providing a tilt to a screen so that the upper part of the screen becomes close to a field of vision of an audience.

Furthermore, the present invention can implement a stereoscopic effect within a screen because the screen has right and left and top and bottom curvature and thus enables an audience to have a 3-D effect when watching a 2-D movie and to have a stereoscopic effect as if the audience watches a picture of an actual event when watching a 3-D movie.

### DESCRIPTION OF DRAWINGS

FIG. 1 is a diagram showing the structure of a screen support having curvature according to an embodiment of the present invention.

FIG. 2 is a plan view showing the structure of the screen support having curvature, which viewed from the top, in accordance with an embodiment of the present invention.

FIG. 3 is a diagram showing a structure in which a screen support having curvature includes a diagonal line post and a beam in accordance with an embodiment of the present invention.

FIG. 4 is a reference diagram for illustrating a change in the curvature and tilt of a curved surface screen according to a movement of a vertical post and horizontal post according to the present invention.

FIG. 5 is a reference diagram illustrating a structure in which the vertical post, the horizontal post, and the screen frame having curvature are coupled in accordance with the present invention.

FIG. 6 is a reference diagram illustrating the structure of the screen frame having curvature.

FIG. 7 is a reference diagram for illustrating an experiment in which a screen is divided into 16 equal parts and the distance in each area is measured in order to check an optimum tilt of the screen frame having curvature according to an embodiment of the present invention.

FIG. 8 is a reference diagram for illustrating an experiment in which an area that belongs to the 16 equal parts of the screen and has sagged is divided into 16 equal parts again and an accurate sagged area is measured in order to check an optimum tilt of the screen frame having curvature according to an embodiment of the present invention.

### MODE FOR INVENTION

The details of the objects and technological configurations of the present invention and acting effects thereof will be more clearly understood from the following detailed description based on the accompanying drawings. Hereinafter, embodiments of the present invention are described in detail with reference to the accompanying drawings.

Embodiments disclosed in this specification should not be interpreted as limiting or used to limit the range of right of the present invention. It is evident to those skilled in the art that a description including the embodiments of this specification has various applications. Accordingly, unless otherwise defined by the claims, some embodiments described are illustrative for better understanding, and the range of right of the present invention is not intended to be restricted by the embodiments.

Function blocks illustrated in the drawings and described hereunder are only examples of possible implementations. In other implementations, different functional blocks may be used without departing from the spirit and scope of the detailed description. Furthermore, one or more functional blocks of the present invention are illustrated as separate blocks, but one or more of the functional blocks of the present invention may be a combination of various hardware and software elements for executing the same function.

Furthermore, it should be understood that an expression that some elements are included is an expression of an open type and the expression simply denotes that the corresponding elements are present, but does not exclude additional elements.

Furthermore, when it is said that one element is connected or coupled to the other element, it should be understood that one element may be directly connected or coupled to the other element, but a third element may exist between the two elements. Furthermore, expressions, such as “the first” and “the second”, are expressions used to only distinguish a plurality of elements from one another, and do not limit the sequence of the elements or other characteristics.

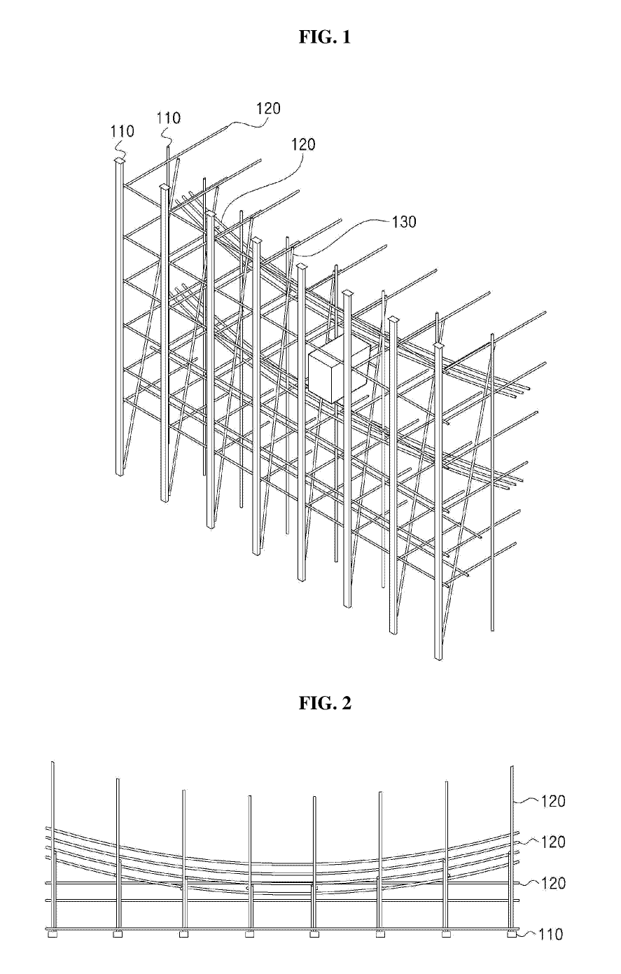

FIG. 1 is a diagram showing the structure of a screen support 100 having curvature according to an embodiment of the present invention.

Referring to FIG. 1, the screen support 100 having curvature according to an embodiment of the present invention includes a plurality of vertical posts 110 disposed in a vertical direction to the ground and a plurality of horizontal posts 120 having one ends joined to the vertical posts 110 in a horizontal direction to the ground. In this case, a line connecting the other ends of the respective horizontal posts 120 disposed in the same vertical axis may form a curve shape having curvature of a specific size, and a line connecting the other ends of the respective horizontal posts 120 disposed in the same horizontal axis may form a curve shape having curvature of a specific size. In this case, if “one end” is an end on any one side of a member, “the other end” means an end on the other end of the same member.

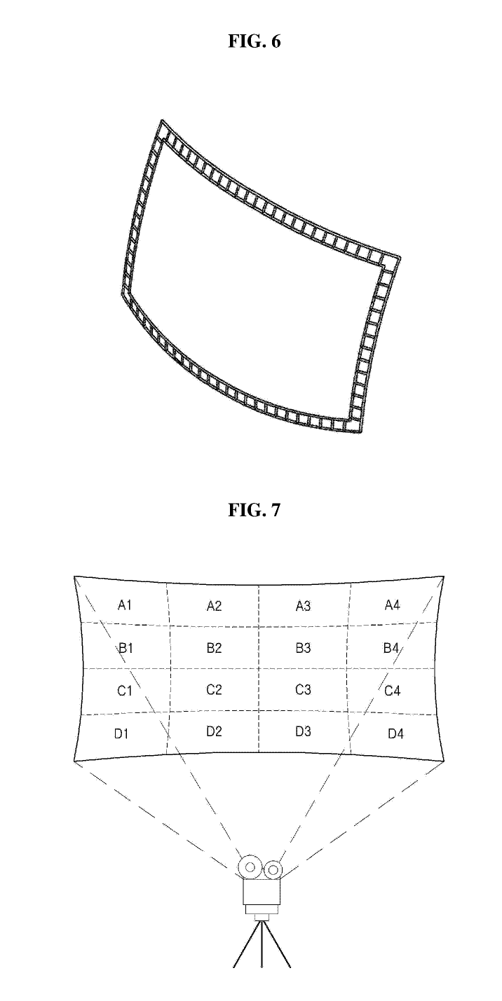

In this case, the horizontal post 120 joined to the uppermost end of the vertical post 110 may be inclined toward the ceiling at a specific angle or the horizontal post 120 joined to the lowermost end of the vertical post 110 may be inclined toward the ground at a specific angle and may be then joined to a screen frame having curvature (refer to FIG. 6) more stably.

The support refers to a structure, basically including the vertical post 110 having a fixed framework fixed to the ground and the horizontal post 120 having one end joined to the vertical post 110 and having the other end joined to a frame or a screen 10 having curvature.

The vertical post 110 and the horizontal post 120 are framework materials of a structure installed to support the screen 10 having curvature and the frame of the screen having curvature. It is preferred that the vertical post 110 and the horizontal post 120 are made of a solid material. Furthermore, the horizontal post 120 may be fabricated to have a different length because the distance from the vertical post 110 to each portion of the screen 10 having curvature is different due to curvature of the screen from the nature of the screen 10 having curvature. More specifically, it is preferred that a line connecting the other ends of the respective horizontal posts 120 disposed in the same horizontal axis forms a curve shape having the same curvature value as curvature of the screen frame having curvature. Furthermore, the vertical post 110 and the horizontal post 120 may be fabricated to have a varying length through control of a theater server so that the shape of the screen is changed.

Meanwhile, the vertical post 110 and the horizontal post 120 may have their length and breadth connection portion primarily fixed using a frame connection joint. A welding task may be secondarily performed on a portion to which a heavy load is applied in order to form solid joining.

Furthermore, the screen 10 having curvature collectively refers to projection surfaces mace of various materials and joined to the frame for forming a shape of the screen. The screen 10 refers to a screen having curvature of a specific size in the horizontal axis or vertical axis depending on curvature of the long-axis members or short-axis members that form the frame. In this case, the screen is fabricated to be greater than the frame because perforations are generally formed in the screen uniformly. A shape of the screen 10 having curvature screen is preferably formed in such a way as to bind the long-axis members and short-axis members of a frame (refer to FIG. 6) or post units or beams spaced apart from the members at specific intervals and the screen using a string.

Furthermore, a material of the screen 10 having curvature may include textiles or various kinds in which textiles have been subjected to coating treatment, such as mat white, glass beads, ultra beads, a film, fiber glass and diamond. In this case, the reflectance value (or gain) of the screen preferably is 1.8˜2.4 for 3-D polarization screening. In this case, as the reflectance value increases, it means that an image looks brighter because reflectance of light is high.

Furthermore, the frame (refer to FIG. 6) refers to a structure joined to the support in order to maintain the shape of the screen 10 having curvature. The frame includes a long-axis member or a short-axis member having curvature, and functions to closely attach the screen to the members, eventually implementing the screen 10 having curvature. In this case, the long-axis member is a member longer than the short-axis member. In view of the characteristics of a screen installed on a theater, it is preferred that the long-axis member is disposed in a horizontal-axis direction and the short-axis member is disposed in a vertical-axis direction. In this case, the long-axis member of the frame includes the first long-axis member and the second long-axis member on which the top and bottom of the screen are respectively mounted.

The frame may be modified to have various types of curvature in accordance with an increase or decrease in the length of the vertical post 110 and the horizontal post 120 included in the screen support 100 having curvature. Accordingly, the frame may be preferably fabricated using a material having an elastic force.

Meanwhile, “joining” used in the present invention means that independent members maintain contact with each other, and comprehensively includes meanings, such as binding, attachment, adhesion, coupling, welding and holding. It is evident that the joining of the screen and the frame is not limited to a method for binding the screen and the frame using a string. Accordingly, various methods, such as a method for additionally attaching a magnetic member to the screen 10 and frame having curvature, a method for attaching intake means to the frame so that the screen 10 having curvature is closely attached to the frame and a method for coating an adhesive substance on the frame so that the screen 10 having curvature is closely attached to the frame, may be taken into consideration as the method for joining.

In this case, the definition of curvature used in the present invention is as follows. When a point P on a curved line moves along the curved line at a constant speed, the direction in which the point moves is changed depending on a moved distance (the length of an arc in the curved line) “s.” In this case, a rate of change is called curvature of the curved line. Assuming that a fine movement distance from one point P on a plane curve to a point Q is “s” and an angle (of an increasing direction of “s”) formed by two tangents at the two points P and Q is Δθ, a direction change rate k is given as follows.

$$k = {lim}_{Δ s \to 0} \vert \frac{Δ θ}{Δ s} \vert = \vert \frac{d θ}{d s} \vert \qquad [ Equation 1 ]$$

This is called curvature at the point P of the curved line. Accordingly, curvature of the curved line y=f(x) is:

$$k = \frac{\vert {y}^{″} \vert}{{\{ 1 + {( {y}^{′} )}^{2} \}}^{3 / 2}} \qquad [ Equation 2 ]$$

The reciprocal of k, R=1/k, is called a curvature radius.

FIG. 2 is a plan view showing the structure of the screen support 100 having curvature, which viewed from the top, in accordance with an embodiment of the present invention.

Referring to FIG. 2, in an embodiment of the present invention, the horizontal post 120 has curvature of a specific size, and may be joined to a plurality of the vertical posts 110 or a plurality of other horizontal posts 120 disposed in the same horizontal axis.

In this case, the vertical posts 110 may be disposed in various ways depending on a shape of a theater, such as a straight line (a straight form), a curved line (a round form) or an arrangement (a tile form) in which only vertical posts at right and left ends in the arrangement of a straight line are forward disposed in the straight line depending on a shape of the surface of a wall in a theater.

Furthermore, since the horizontal post 120 having curvature of a specific size is joined to the plurality of vertical posts 110 or a plurality of other horizontal posts 120 disposed in the same horizontal axis, this becomes a base in which a speaker 20 can be held along with the horizontal post 120 forming a cross form by being joined to a plurality of vertical posts 110 in the same row or column. Accordingly, the speaker 20 can be stably held by installing a prop in which the speaker 20 can be held or to which the speaker can be fixed in a portion intersected in the cross form.

Furthermore, the speaker 20 can be disposed close to the screen as close as possible because curvature of the horizontal post 120 is fabricated to have the same curvature of the screen 10. Accordingly, a sound effect can be effectively transferred to an audience because the speaker 20 can be closely attached to the screen as close as possible in accordance with curvature of the screen.

Furthermore, in an embodiment of the present invention, the horizontal post 120 may be joined to a plurality of the vertical posts 110 at a predetermined interval in a direction parallel to one sides formed by the plurality of vertical posts 110. More specifically, the vertical posts 110 may be arrayed in a 2-row or more line, and the horizontal post 120 may be joined to the plurality of vertical posts 110 in the same row or column. If such a structure is adopted, the top and the bottom become a ladder structure. Accordingly, work is facilitated because a worker can easily go up and down without a separate tool, and the support can hold the screen and the speaker more stably because the bottom of the support has a structure to which weight is uniformly distributed.

In another embodiment of the present invention, the screen support 100 having curvature further includes a prop provided in the ground and supporting the vertical post 110. The vertical post 110 may be joined to the prop and directed toward a predetermined direction. If the prop supporting the vertical post 110 is placed as described above, a stabilized structure can be achieved using a small space because a stabilized structure can be taken without a need to erect several vertical posts 110. Furthermore, the vertical post 110 can be disposed at an angle intended by a designer other than the vertical direction by adjusting an angle formed by the prop and the vertical post 110.

Furthermore, in another embodiment of the present invention, in the horizontal post 120, an angle formed by the vertical post 110 and a straight line that connects the other end of the horizontal post at the uppermost end and a horizontal post at the lowermost end disposed in the same vertical post 110 may have 10 to 20 degrees.

The term “tilt” refers to an angle formed by a straight line that connects the first long-axis member and second long-axis member of the frame at the shortest distance and the vertical post 110 of the support. As described above, the long-axis member of the frame includes the first long-axis member and the second long-axis member respectively holding the top and bottom of the screen. The screen frame having curvature is joined to the other end of the horizontal post 120 of the support, thus forming a tilt. Accordingly, an angle formed by the vertical post 110 and a straight line that connects the other ends of the respective horizontal posts 120 disposed in the same vertical post 110 of the support means the tilt of the screen 10 having curvature. Furthermore, it is preferred that the vertical post 110 is vertically disposed with respect to the ground. The “tilt” refers to an angle formed by a straight line that connects the other ends of the respective horizontal posts 120 disposed in the same vertical post 110 and a straight line vertical to the ground.

As described above, the reason why curvature and a tilt are to be formed in the screen using the screen support 100 having curvature according to the present invention is as follows.

The screen 10 having curvature provides a sense of immersion compared to a plane screen, but may generate problems, such as the sagging of the screen depending on curvature of the frame, an unbalanced luminosity distribution of the screen, etc.

Accordingly, if the screen 10 having curvature is installed, a phenomenon in which some area of the screen sags and a phenomenon in which there is a luminosity difference between the center and corner of the screen are generated. The following experiment was performed in order to find out an optimum shape that gives a new sense of immersion while minimizing such a phenomenon.

First, a distance measuring device was disposed at a distance of 10000 mm (10 M) from the center of the surface of a wall where the screen was to be installed. The screen was divided into 16 equal parts as shown in FIG. 7. After a lapse of one week, the degree of sagging of the screen was measured by measuring the distance up to each of the 16 areas.

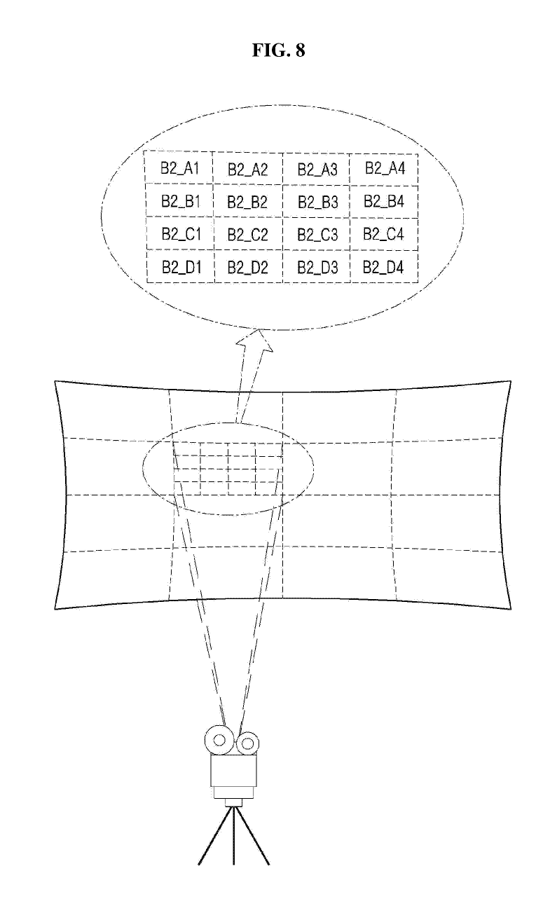

In this case, a difference between an optimum value from the point at which the distance measuring device was disposed to each area of the screen and a value actually measured by the distance measuring device was calculated. If the difference was ±300 mm or more, a sag phenomenon was determined to be generated. If a sag phenomenon was generated in a specific area, the specific area was divided into 16 equal parts again as shown in FIG. 8. A distance up to each of the 16 areas was measured again. An area having a difference of ±300 mm or more was calculated to check a more accurate degree of sag.

In this case, the optimum value was based on a value obtained by measuring the distance after the screen was first installed, and is shown in Table 1. The tilt was 16 degrees, 24 degrees and 30 degrees. The distances checked after one week are shown.

TABLE 1

| Optimum distance | | | | |
|---|---|---|---|---|
| (mm in unit) | 1 | 2 | 3 | 4 |
| A | 8530 | 9020 | 9020 | 8530 |
| B | 9040 | 9130 | 9130 | 9040 |
| C | 9490 | 9160 | 9160 | 9490 |
| D | 9950 | 9240 | 9240 | 9950 |

TABLE 2

| Tilt of 16 degrees | | | | | |
|---|---|---|---|---|---|
| (mm in difference) | 1 | 2 | 3 | 4 | |
| A | 230 | 220 | 140 | 80 | Sag of 2% |
| B | 240 | 370 | 240 | 200 | generated |
| C | 50 | 230 | 340 | 490 | |
| D | 20 | 40 | 20 | 30 | |

TABLE 3

| Tilt of 24 degrees | | | | | |
|---|---|---|---|---|---|
| (mm in difference) | 1 | 2 | 3 | 4 | |
| A | 220 | 110 | 140 | 130 | Sag of |
| B | 340 | 450 | 360 | 340 | 17% |
| C | 230 | 140 | 150 | 120 | generated |
| D | 30 | 20 | 50 | 120 | |

TABLE 4

| Tilt of 30 degrees | | | | | |
|---|---|---|---|---|---|
| (mm in difference) | 1 | 2 | 3 | 4 | |
| A | 260 | 210 | 190 | 170 | Sag of |
| B | 410 | 230 | 450 | 310 | 26% |
| C | 260 | 320 | 370 | 220 | generated |
| D | 30 | 20 | 10 | 50 | |

Referring to Table 1 to Table 4, it was found that if the tilt was 24 degrees, a sag phenomenon was partially generated at the upper end of the central portion of the screen and if the tilt was 30 degrees, sagging was generally generated in the central portion of the screen and thus the tilt was not an angle optimized for movie watching.

Accordingly, the degree of sag was the least at the tilt of 16 degrees. As a result of the adjustment of the tilt from 16 degrees, when the tilt was 20 degrees or less, the degree of sag was rarely generated. When the tilt becomes 10 degrees or less, there was a disadvantage in that a stereoscopic effect and a sense of immersion were deteriorated when visual media is played back. Accordingly, it could be checked that when the tilt was 10 to 20 degrees, a sense of immersion was maintained and sag was less generated.

Thereafter, the ratio of the curvature radii of the first long-axis member: the second long-axis member: the short-axis member based on the tilt of 16 degrees having the smallest sag phenomenon was 1:1:1 (Case 1), 1:1:0.8 (Case 2), 1:1:1.2 (Case 3), 1:1.2:1 (Case 4), 1:1.2:0.8 (Case 5), 1:1.2:1.2 (Case 6) and 1:1.2:1.5 (Case 7). In this state, an experiment was performed in the same manner. If, as a result of the experiment, the ratio of the first long-axis member and the second long-axis member is the same (Case 1˜Case 3), it was found that a sag phenomenon was relatively less generated. In the case of Case 2, a sag phenomenon was less generated while the best sense of immersion was maintained.

Meanwhile, in order to check the ratio of the curvature radius of the frame in which a luminosity difference between the center and corner of the screen was the least, an experiment in which the ratio of the curvature radius of the frame was changed, the screen was divided into 16 equal parts, and brightness (i.e., an amount obtained by dividing luminous intensity of a light source having a specific range by the area of the light source) of the screen was performed in the state in which the tilt was set to 10 to 20 degrees.

First, a test image (black image) from a projector was projected on the screen, a luminosity measuring device was disposed at a distance of 10 M from the center of the surface of a wall, and luminosity in each area was measured.

In general, screen luminosity was measured to be bright at the central portion and was measured to be darker toward the end. A luminosity difference between the center point and an end point is less, and an image is sharp and a sense of difference is reduced as the number of bright points is increased. An equation for giving a higher score to a more uniform luminosity distribution was created, and the scores were evaluated based on the equation.

Accordingly, a score evaluated in the frame of each curvature radius is as follows:

An evaluation score=10 scores−(a standard deviation of a brightness areas divided into 16 equal parts).

Several types of frame curvature was generated, and the results of the measurement of scores according to a luminosity distribution are shown in Table 5. In this case, the unit of measured brightness was fL.

TABLE 5
Brightness distribution
(Brightness fL)

| | First long-axis | | | |
|---|---|---|---|---|
| | member:second long- | | | |
| | axis member | | | |
| Short-axis | 8,000:8,000 | | | |
| member | 10.1 | 11.4 | 12.3 | 11.5 |
| curvature | 10.7 | 14.6 | 12.7 | 9 |
| 8,000 | 9.3 | 12.7 | 13 | 12 |
| | 11 | 11.4 | 11.5 | 11 |
| | 8.6 score | | | |
| | 10,000:10,000 | | | |
| | 10.1 | 11.5 | 12.4 | 11.9 |
| | 10.4 | 12.6 | 12.7 | 11.2 |
| | 11.4 | 12.7 | 12.8 | 12 |
| | 11.5 | 11.2 | 12.1 | 11.1 |
| | 9.2 score | | | |
| | 15,000:15,000 | | | |
| | 10.2 | 11.4 | 12.4 | 11.2 |
| | 11.3 | 12.5 | 11.2 | 10.3 |
| | 11.6 | 12.7 | 12.4 | 11.4 |
| | 10.4 | 9.9 | 11.5 | 10.4 |
| | 9.1 score | | | |
| Short-axis | 10,000:8,000 | | | |
| member | 6.6 | 11.4 | 12.3 | 5.6 |
| curvature | 8.5 | 13.5 | 11.2 | 7.6 |
| 10,000 | 9.3 | 12.7 | 13 | 12 |
| | 7.7 | 9.9 | 11.5 | 8.8 |
| | 7.5 score | | | |
| | 8,000:10,000 | | | |
| | 3 | 6.7 | 8.8 | 3.4 |
| | 4.1 | 13.7 | 12.4 | 7.4 |
| | 2.6 | 8.6 | 7.8 | 4.1 |
| | 5.1 | 3 | 3.1 | 4 |
| | 6.6 score | | | |
| | 15,000:15,000 | | | |
| | 9.7 | 10.2 | 10 | 9.8 |
| | 10.4 | 11.2 | 12.1 | 11.2 |
| | 10.2 | 11.4 | 10.2 | 10.9 |
| | 8.9 | 9.7 | 9.8 | 10 |
| | 9.2 score | | | |
| Short-axis | 8,000:8,000 | | | |
| member | 1.6 | 3.5 | 4.3 | 1 |
| curvature | 2.5 | 16 | 14 | 0.2 |
| 15,000 | 1 | 8.3 | 6.8 | 2.1 |
| | 3.2 | 5 | 2.4 | 1.5 |
| | 5.4 score | | | |
| | 10,000:10,000 | | | |
| | 5.3 score | | | |
| | 15,000:15,000 | | | |
| | 8.6 | 11.4 | 12.3 | 7.9 |
| | 9.2 | 13.5 | 11.2 | 8.9 |
| | 9.3 | 12.7 | 13 | 10 |
| | 9.3 | 9.9 | 11.5 | 8.8 |

8.2 score

Furthermore, the results of a luminosity distribution of the screen visually expressed based on the scores of the experiment may be understood to be the same degree as luminosity distributions of Table 6.

Referring to Table 5, the ratio of the curvature radii of the first long-axis member: the second long-axis member: the short-axis member having 8 scores or more was 8000:8000:8000 (8.6 score), 10000:10000:8000 (9.2 score), 15,000:15,000:8000 (9.1 score), 15,000:15,000:10,000 (9.2 score), and 15,000:15,000:15,000 (8.2 score). It may be seen that a luminosity distribution is the most uniform in a range of 1:1:0.6-1.0 if the ratio is reduced to its lowest terms.

Accordingly, if the screen having curvature is installed, the results of the experiment revealed that when the tilt is set to 10 to 20 degrees and the ratio of curvature is set to 1:1:0.6˜1.0, a phenomenon in which the screen sags and a phenomenon in which a luminosity difference is generated between the center and corer of the screen can be solved.

Accordingly, as a result of the adjustment of a tilt and curvature after several ratios were set as in the experiment, if the ratio is 1:1:0.6˜1.0 and the tilt is 10 to 20 degrees, there are advantages in that sag is rarely generated, screen luminosity is uniformly distributed and a maximum sense of immersion can be provided to an audience. More specifically, if visual media is projected on the screen 10 having curvature in which the ratio of the curvature radius is 1:1:0.8 and the tilt is 16 degrees as in the ratio of 10000:10000:8000 (9.2 score), it can be seen that a 2-D movie has the same effect as a 3-D movie and a 3-D movie has an effect of the feeling of movement much higher than that of a plane screen because the distance from a projector from which an image is projected to the screen is different due to the characteristics of the screen having curvature.

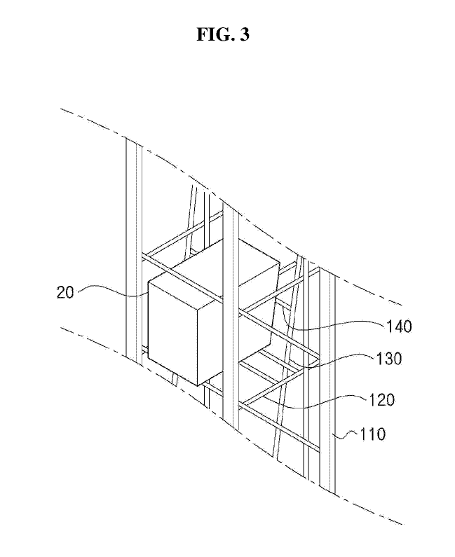

FIG. 3 is a diagram showing a structure in which a screen support having curvature includes a diagonal line post 130 and a beam 140 in accordance with an embodiment of the present invention.

Referring to FIG. 3, the screen support 100 having curvature according to an embodiment of the present invention may further include a diagonal line post 130 joined to one point of a vertical post 110 to form an angle of 10 to 20 degrees along with the vertical post and a beam 140 vertically joined to an adjacent diagonal line post 130 or may further include a diagonal line post 130 joined to one points of a plurality of horizontal posts 120 disposed in the same vertical post 110 to form an angle of 10 to 20 degrees along with the vertical post 110 and a beam 140 vertically joined to an adjacent diagonal line post 130. In this case, the surface of a wall means the surface of a wall on which a screen within a theater is to be installed.

Accordingly, when the diagonal line post 130 is present as shown in FIG. 3, the diagonal line post 130 is joined to the horizontal post 120 at the upper end from the lower end. Accordingly, the horizontal post at the upper end can be stably joined to the frame although it becomes distant from a vertical post portion to which the horizontal post has been joined. Furthermore, a sound can be transferred because the speaker 20 is closely attached to the screen 10 as close as possible in accordance with a screen having a tilt. Accordingly, the diagonal line post 130 holds the beam 140 so that it is not detached from the speaker 20, thus preventing an accident that the speaker 20 falls.

Furthermore, in another embodiment of the present invention, the horizontal post 120 or the vertical post 110 may have a length increased or decreased in the horizontal direction or vertical direction. A method capable of adjusting the length of the horizontal post 120 or the vertical post 110 may include all of various methods including a method using a hydraulic cylinder.

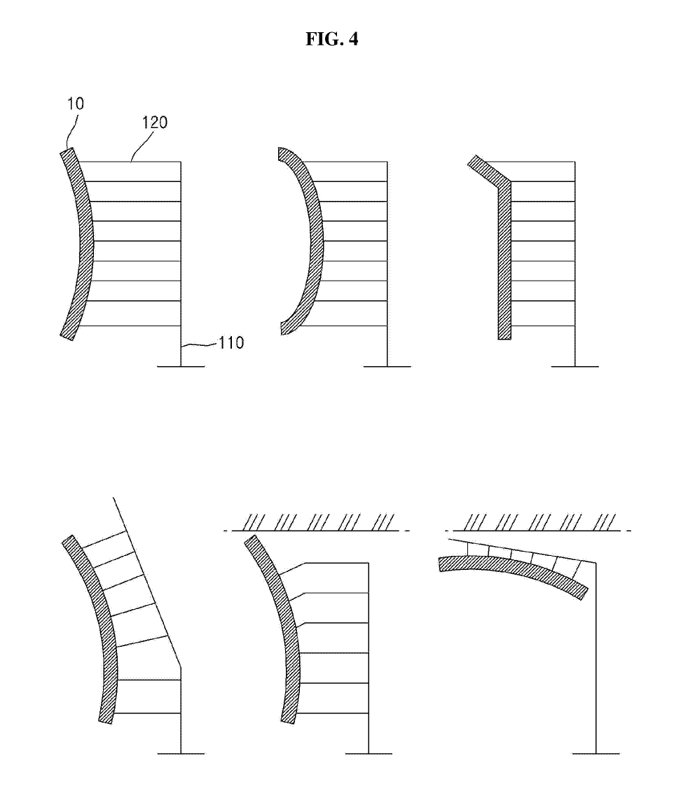

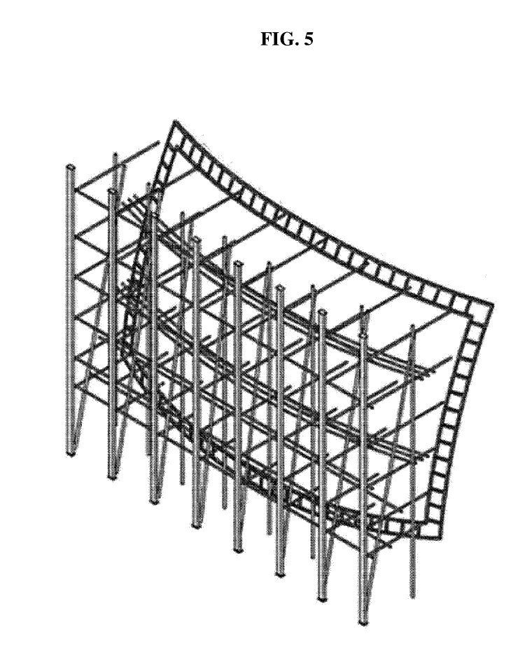

Meanwhile, the tilt of the horizontal post 120 or vertical post 110 according to the present invention may also be adjusted in addition to an increase or decrease in the length thereof. That is, an angle formed by the horizontal post 120 or vertical post 110 and the surface of a wall or an angle formed by the horizontal post 120 or vertical post 110 and the ground may be controlled by a theater server to be described later. Accordingly, the horizontal post 120 or the vertical post 110 may be inclined in the direction of audiences or may be inclined in a direction distant from audiences (refer to FIG. 4).

More specifically, the plurality of horizontal posts 120 and vertical posts 110 may be identified by unique identifiers. That is, a unique identifier may be assigned to each horizontal post 120 or vertical post 110 fixed to any specific location of the frame. The length of each horizontal post 120 or vertical post 110 to be increased or decreased is determined so that the horizontal posts 120 or the vertical posts 110 can be individually controlled. If the plurality of horizontal posts 120 or vertical posts 110 is individually controlled as described above, there is an advantage in that a sense of immersion and a stereoscopic effect can be more effectively provided to an audience because a theater operator or a content producer can change curvature of the curved surface screen more minutely.

Furthermore, if the horizontal posts 120 or the vertical posts 110 are individually controlled as described above, curvature of the curved surface screen in both the horizontal direction and the vertical direction can be generated. Accordingly, there is an advantage in that a curved surface of ovalness (a curved surface having both curvature in the horizontal direction and curvature in the vertical direction) can be implemented.

Meanwhile, effects attributable to an increase or decrease in the length of the horizontal post 120 and the vertical post 110 and a change in the tilt of the horizontal post 120 and the vertical post 110 are as follows.

First, when the length of the vertical post 110 is adjusted, the height of the screen can be changed. This can provide an audience with an experience including the feeling of movement because the length is adjusted along with the angle of an audience seat within a theater. A control server to be described later may previously set the length of each of the vertical posts 110 according to the running time of a movie, and may control the length of the vertical post 110 according to the running time of a movie.

For example, if the above effect is used in a roller coaster riding scene, a spacecraft battle scene or a car chase scene, an audience can feel a screening scene as if he or she actually experiences the scene.

Second, when the length of the horizontal post 120 is adjusted, curvature of the screen can be changed. This can represent various effects compared to an existing plane type screen by changing curvature of the screen in each specific scene of a movie. The control server to be described later may previously set the lengths of the horizontal posts 120 according to the running time of a movie, and may control the lengths of the horizontal posts 120 according to the running time of a movie.

For example, an expression having the feeling of movement may be applied to the screen using the above effect in a scene in which a planet explodes, a scene in which an EMP pulse spreads outs or a scene in which a nuclear bomb explodes.

Third, when the angle of the vertical post 110 is adjusted, an angle of the screen toward an audience can be adjusted. This can represent various effects compared to an existing plane type screen by adjusting the angle of the screen in a specific scene of a movie. The control server to be described later may previously set the angles of the vertical posts 110 according to the running time of a movie, and may control the angles of the vertical posts 110 according to the running time of a movie.

Fourth, when the angle of the horizontal post 120 is adjusted, curvature of the screen can be changed. This can represent various effects compared to an existing plane type screen by adjusting curvature of the screen in a specific scene of a movie. The control server to be described later may previously set the angles of the horizontal posts 120 according to the running time of a movie, and may control the angles of the horizontal posts 120 according to the running time of a movie.

As described above, a method for controlling the length and angle of the vertical post 110 and the horizontal post 120 is described below as an example. Assuming that R1 and R2 are horizontal-direction curvature and vertical-direction curvature of the screen 10 having curvature, respectively, and a tilt is an angle formed by the vertical post 110 and the ground, the length and angle of the vertical post 110 and the horizontal post 120 are controlled by setting R1 to 6000, R2 to 4000 and the tilt to 90 degrees when advertising is played back prior to the playback of a content image, setting R1 to 7000, R2 to 10000 and the tilt to 82 degrees when a scene 1 of the content image is played back, and setting R1 and R2 to 6000 and the tilt to 70 degrees when a scene2 is played back.

Furthermore, assuming that R1 and R2 are horizontal-direction curvature and vertical-direction curvature of the screen 10 having curvature, respectively, and H is the height of the vertical post 110, the length and angle of the vertical post 110 and the horizontal post 120 are controlled by setting R1 to 6000, R2 to 4000 and the height of the vertical post 110 to 0 when a content image is first started, setting R1 to 7000, R2 to 10000 and the height of the vertical post to 1 from a point of time of 1 minute 23 seconds of the content image to a point of time of 9 minutes 34 seconds, and setting R1 and R2 to 6000 and the height of the vertical post 110 to 0 up to a point of time of 23 minutes 41 seconds.

Furthermore, a theater equipped with the screen support 100 having curvature according to the present invention may include a support having all of the aforementioned characteristics of the screen support 100 having curvature, and a redundant description thereof is omitted.

A system for controlling the screen support 100 having curvature according to an embodiment of the present invention includes the screen support 100 having curvature and the control server.

The screen support 100 having curvature includes the plurality of vertical posts 110 erect from the ground in the vertical direction and the plurality of horizontal posts 120 joined to the vertical post 110 in the direction horizontal to the ground. The length of the vertical post 110 or the horizontal post 120 may be extended or reduced, and a predetermined portion of the vertical post 110 or the horizontal post 120 may be refracted at a predetermined angle.

The control server may previously set the length and angle of each of the vertical posts 110 or the horizontal posts 120 according to the running time of a movie, and may control the length and angle of each of the vertical posts 110 or the horizontal posts 120 according to the running time of a movie. FIG. 4 is a reference diagram for illustrating a change in the curvature and tilt of a curved surface screen according to a movement of the vertical post 110 and the horizontal post 120 according to the present invention. The screen 10 having curvature may have various types of curvature and angles as shown in FIG. 4.

For example, when a scene in which a spacecraft departs at 30 minutes 20 seconds is played back, control may be performed so that the length of the horizontal post 120 joined to the upper part of the screen is extended and at the same time, an audience seat is bent back so that an audience has a feeling of being directed toward the universe.

At this time, the screen support 100 having curvature has a hydraulic cylinder provided in a predetermined portion of the vertical post 110 or the horizontal post 120, and thus the length of the screen support 100 may be extended or reduced. The predetermined portion may be refracted at a predetermined angle. The control server may previously set the amount of hydraulic pressure of the hydraulic cylinder according to the running time of a movie, and may control the amount of hydraulic pressure of the hydraulic cylinder according to the running time of a movie.

Furthermore, the screen support 100 having curvature, that is, an element of a system for controlling the screen support 100 having curvature according to the present invention, may have all of the aforementioned characteristics, and a redundant description thereof is omitted.

A method for installing the screen support 100 having curvature according to an embodiment of the present invention includes the steps of (a) disposing the plurality of vertical posts 110 in the vertical direction to the ground and (b) joining one ends of the horizontal posts 120 to the vertical posts 110 in the horizontal direction to the ground, wherein the step (b) may include disposing the horizontal posts 120 so that a line connecting the other ends of the respective horizontal posts 120 disposed in the same vertical axis forms a curve shape having curvature of a specific size and a line connecting the other ends of the respective horizontal posts 120 disposed in the same horizontal axis forms a curve shape having curvature of a specific size.

In this case, at the step (b), a horizontal post joined to the uppermost end of a vertical post may be inclined toward the ceiling at a specific angle, and a horizontal post joined to the lowermost end of the vertical post may be inclined toward the ground at a specific angle so that the horizontal post can be joined to the screen frame having curvature more stably.

Furthermore, the method may further include the step of joining a horizontal post 120 having curvature of a specific size to a plurality of vertical posts 110 or a plurality of horizontal posts 120 disposed in the same horizontal axis, after the step (b).

In this case, at the step (a), the vertical posts 110 are disposed in a 2-row or more line. The method may further include the step of joining the horizontal post 120 to the plurality of vertical posts 110 in the same row or column after the step (b).

Furthermore, at the step (b), an angle formed by a line connecting the other ends of a horizontal post at the uppermost end and a horizontal post at the lowermost end disposed in the same vertical post 110 and the vertical post 110 may have 10 to 20 degrees. Furthermore, the method may further include the steps of joining one point of the vertical post 110 and the diagonal line post 130 to form an angle of 10 to 20 degrees along with the vertical post 110 disposed to be the closest to the surface of a wall and joining the beam 140 in a direction vertical to an adjacent diagonal line post 130, after the step (b). In this case, the surface of a wall means the surface of a wall on which a screen is to be installed within a theater.

More specifically, the method may further include the steps of joining one points of a plurality of horizontal posts disposed in the same vertical post 110 and the diagonal line post 130 to form an angle of 10 to 20 degrees along with the vertical post; and joining the beam 140 in a direction vertical to an adjacent diagonal line post 130, after the step (b).

In this case, the length of the horizontal post 120 or the vertical post 110 in the horizontal direction or vertical direction according to the present invention may be increased or decreased, and the tilt of the horizontal post 120 or the vertical post 110 may also be adjusted in addition to the increase of the length, and a redundant description thereof is omitted.

As described above, those skilled in the art to which the present invention pertains will understand that the present invention may be implemented in other detailed forms without changing the technological spirit or essential characteristics of the present invention. Accordingly, the aforementioned embodiments should not be construed as being limitative, but should be construed as being only illustrative from all aspects. The range of right of the present invention is disclosed in the appended claims rather than the detailed description, and it should be understood that all modifications or variations derived from the meanings and scope of the present invention and equivalents thereof are included in the scope of the appended claims.

### INDUSTRIAL APPLICABILITY

The present invention relates to a screen support having curvature and, more particularly, to a screen support having curvature including a plurality of vertical posts disposed in a vertical direction to the ground and a plurality of horizontal posts having one ends joined to the vertical posts in a horizontal direction to the ground, wherein a line connecting the other ends of the respective horizontal posts disposed in the same vertical axis forms a curve shape having curvature of a specific size and a line connecting the other ends of the respective horizontal posts disposed in the same horizontal axis forms a curve shape having curvature of a specific size. Accordingly, a screen having curvature in the vertical axis in addition to the horizontal axis can be stably held, and a high feeling of movement can be delivered to an audience by controlling curvature and angle of the screen having curvature according to the running time of a movie.

1.-30. (canceled)

31. A screen support having curvature, comprising:
a plurality of vertical posts disposed in a vertical direction to a ground; and
a plurality of horizontal posts having one ends joined to the vertical posts in a horizontal direction to the ground,
wherein a line connecting other ends of the respective horizontal posts disposed in the same vertical axis forms a curve shape having curvature of a specific size, and
a line connecting other ends of the respective horizontal posts disposed in the same horizontal axis forms a curve shape having curvature of a specific size.

32. The screen support of claim 31, wherein a horizontal post joined to an uppermost end of the vertical post is inclined toward a ceiling at a specific angle.

33. The screen support of claim 31, wherein a horizontal post joined to a lowermost end of the vertical post is inclined toward the ground at a specific angle.

34. The screen support of claim 31, wherein the horizontal post has curvature of a specific size and is joined to the plurality of vertical posts or a plurality of other horizontal posts disposed in the same horizontal axis.

35. The screen support of claim 34, wherein:
the vertical posts are disposed in a 2-row or more line, and
the horizontal post is joined to a plurality of vertical posts in the same row or column.

36. The screen support of claim 31, wherein in the horizontal post, an angle formed by a line connecting other ends of a horizontal post at an uppermost and a horizontal post at a lowermost end disposed in the same vertical post and the vertical post has 10 to 20 degrees.

37. The screen support of claim 36, further comprising:
a diagonal line post joined to one point of a vertical post to form an angle of 10 to 20 degrees along with the vertical post; and
a beam vertically joined to an adjacent diagonal line post.

38. The screen support of claim 36, further comprising:
a diagonal line post joined to one points of a plurality of horizontal posts disposed in the same vertical post to form an angle of 10 to 20 degrees along with the vertical post; and
a beam vertically joined to an adjacent diagonal line post.

39. The screen support of claim 31, wherein a length of at least one of the horizontal post and the vertical post is increased or decreased.

40. The screen support of claim 31, wherein a predetermined portion of at least one of the horizontal post and the vertical post is capable of being refracted at a predetermined angle.

41. A screen support, comprising:
a plurality of vertical posts disposed in a vertical direction to a ground; and
a plurality of horizontal posts having one ends joined to the vertical posts,
wherein a horizontal post joined to an uppermost end of the vertical post is inclined toward a ceiling at a specific angle, a horizontal post joined to a lowermost end of the vertical post is inclined toward the ground at a specific angle, and both the horizontal posts are joined to a screen frame having curvature.

42. The screen support of claim 41, wherein an angle formed by a line connecting other ends of a horizontal post at an uppermost and a horizontal post at a lowermost end disposed in the same vertical post and the vertical post has 10 to 20 degrees.

43. A method for installing a screen support having curvature, comprising steps of:
(a) disposing a plurality of vertical posts in a vertical direction to a ground; and
(b) joining one ends of horizontal posts to the vertical post in a horizontal direction to the ground,
wherein the step (b) comprises disposing the horizontal posts so that a line connecting other ends of the respective horizontal posts disposed in the same vertical axis forms a curve shape having curvature of a specific size and a line connecting other ends of the respective horizontal posts disposed in the same horizontal axis forms a curve shape having curvature of a specific size.

44. The method of claim 43, wherein at the step (b), a horizontal post joined to an uppermost end of the vertical post is inclined toward a ceiling at a specific angle, and a horizontal post joined to a lowermost end of the vertical post is inclined toward the ground at a specific angle.

45. The method of claim 43, further comprising a step of joining a horizontal post having curvature of a specific size to the plurality of vertical posts or a plurality of horizontal posts disposed in the same horizontal axis, after the step (b).

46. The method of claim 45, wherein:
at the step (a), the vertical posts are disposed in a 2-row or more line, and
the method further comprises a step of joining a horizontal post to a plurality of vertical posts in the same row or column after the step (b).

47. The method of claim 43, wherein at the step (b), an angle which is formed by a line connecting other ends of a horizontal post at an uppermost and a horizontal post at a lowermost end disposed in the same vertical post and the vertical post has 10 to 20 degrees.

48. The method of claim 47, further comprising steps of:
joining one point of a vertical post and one end of a diagonal line post to form an angle of 10 to 20 degrees along with the vertical post; and
vertically joining a beam to an adjacent diagonal line post, after the step (b).

49. The method of claim 47, further comprising steps of:
joining one points of a plurality of horizontal posts disposed in the same vertical post and a diagonal line post to form an angle of 10 to 20 degrees along with the vertical post; and
vertically joining a beam to an adjacent diagonal line post, after the step (b).
